(19) United States
(12) Patent Application Publication
(10) Pub. No.: US 2018/0169934 A1
(43) Pub. Date: Jun. 21, 2018

(54) 3D PRINTING DATA GENERATION METHOD AND DEVICE

(71) Applicant: Beijing Xiaomi Mobile Software Co., Ltd., Beijing (CN)

(72) Inventors: Huayijun LIU, Beijing (CN); Tao CHEN, Beijing (CN)

(73) Assignee: Beijing Xiaomi Mobile Software Co., Ltd., Beijing (CN)

(21) Appl. No.: 15/844,962

(22) Filed: Dec. 18, 2017

(30) Foreign Application Priority Data
Dec. 16, 2016 (CN) 201611168444.1

(51) Int. Cl. B29C 64/10; G06K 9/00; B33Y 50/00

(52) U.S. Cl. CPC B29C 64/10; G06K 9/00201; G02B 2027/0178; G06T 2200/04; B33Y 50/00

(57) ABSTRACT

Devices and methods are provided for generating 3D printing data. The method may be applied to small glasses. The method may include: recognizing an object to be scanned; scanning the object to be scanned to obtain a scanning result. The device may then generate 3D printing data according to the scanning result; and send the 3D printing data to an operating device corresponding to the operation item according to a selected operation item.

### CROSS-REFERENCE TO RELATED APPLICATION

This application is based upon and claims priority to Chinese Patent Application No. 201611168444.1 filed on Dec. 16, 2016, the disclosure of which is incorporated by reference herein in its entirety.

### TECHNICAL FIELD

The embodiments of the present disclosure generally relate to the technical field of image processing, and more particularly, to a Three-Dimensional (3D) printing data generation method and device.

### BACKGROUND

3D printing is a rapid prototyping technology, and is a technology for constructing an object on the basis of a digital model file in a layer-by-layer printing manner by using a bondable material such as powder metal or plastics.

3D printing is usually implemented by adopting a digital-technology-based material printer, was usually used for manufacturing a model in the fields of mold manufacture, industrial design and the like, and later, has gradually been used for directly manufacturing some products. There have been parts printed by virtue of such a technology. The technology is applied to jewelries, shoes, industrial design, buildings, Architecture Engineering and Construction (AEC), automobiles, the aerospace, the dental and medical industry, education, geographical information systems, civil engineering, guns and other fields.

However, the conventional 3D printing technology requires a designer to firstly create a model with Computer-Aided Design (CAD) or modeling software and then obtain “regional sections” of the created 3D model, thereby guiding the printer to perform layer-by-layer printing.

### SUMMARY

According to a first aspect of the present disclosure, a 3D printing data generation method is provided, which may be applied to a smart glass, the method may include: an object to be scanned is recognized; the object to be scanned is scanned to obtain a scanning result; 3D printing data is generated according to the scanning result; and the 3D printing data is sent, according to a selected operation item, to an operating device corresponding to the operation item.

According to a second aspect of the present disclosure, a 3D printing data generation device is provided, which may be applied to smart glasses and include: a processor; and a memory configured to store instructions executable by the processor, wherein the processor may be configured to: recognize an object to be scanned; scan the object to be scanned to obtain a scanning result; generate 3D printing data according to the scanning result; and send, according to a selected operation item, the 3D printing data to an operating device corresponding to the operation item.

According to a third aspect of the present disclosure, a non-transitory computer readable storage medium is provided, which has stored therein, instructions, which, when executed by a processor, cause the processor to execute the 3D printing data generation method described in the first aspect.

It will be appreciated that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flow chart showing a 3D printing data generation method, according to an aspect of the disclosure.

FIG. 2 is a flow chart showing a 3D printing data generation method, according to another aspect of the disclosure.

FIG. 3 is a display diagram of smart glasses, according to an aspect of the disclosure.

FIG. 4 is a flow chart showing a 3D printing data generation method, according to an aspect of the disclosure.

FIG. 5 is a display diagram of smart glasses, according to another aspect of the disclosure.

FIG. 6 is a block diagram of a 3D printing data generation device, according to an aspect of the disclosure.

FIG. 7 is a block diagram of a recognition module, according to an aspect of the disclosure.

FIG. 8 is a block diagram of a scanning module, according to an aspect of the disclosure.

FIG. 9 is a block diagram of a 3D printing data generation device, according to an aspect of the disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

The technical solutions provided by the embodiments of the present disclosure relate to smart glasses. 3D data is acquired through the smart glasses, and a user does not need to adopt professional modeling software for designing. Therefore, an acquisition difficulty and cost of the 3D printing data are reduced, and simplicity for an operation of the user is ensured, thereby reducing a use threshold of the 3D printing for ordinary users and improving user experiences in the smart glasses and 3D printing.

The smart glasses in the embodiments integrate at least one of the following sensors: an infrared sensor, an image recognition sensor, and an ultrasonic ranging sensor, so that the smart glasses are endowed with a function of scanning a 3D object. Moreover, the smart glasses may establish connection with another device in a manner of BT, a wireless local area network and the like.

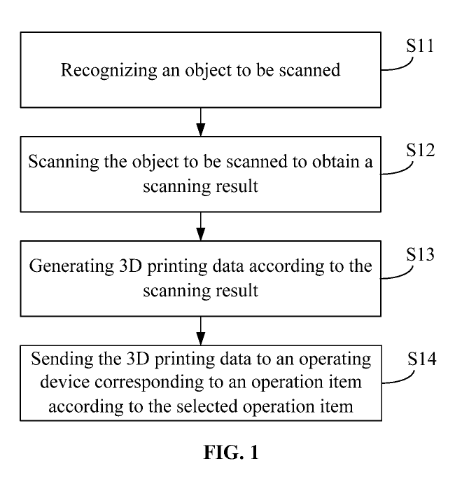

FIG. 1 is a flow chart showing a 3D printing data generation method, according to an aspect of the disclosure. As shown in FIG. 1, the 3D printing data generation method may be implemented in smart glasses. The method may include Steps S11-S14.

In Step S11, an object to be scanned is recognized. The smart glasses may scan the object using one or more sensors using visible light, invisible light, or ultrasound waves, etc.

In Step S12, the object to be scanned is scanned to obtain a scanning result. The smart glasses may obtain the scanning result by detecting the reflected light from outer surfaces of the object.

In Step S13, 3D printing data is generated according to the scanning result. The smart glasses may generate the 3D printing data according to the scanning result using

In Step S14, the 3D printing data is sent, according to a selected operation item, to an operating device corresponding to the operation item. The smart glasses may send the 3D printing data to the operating device, which may be a 3D printer or is in communication with a 3D printer.

In some embodiments, the smart glasses have a 3D scanning function, the object to be scanned is scanned through the smart glasses, the 3D printing data in a format supported by a 3D printer is generated from the scanning result, and the 3D printing data is sent to a specified operating device, such as the 3D printer, another user terminal, or a cloud server, in a wireless manner. In such a manner, a user does not need to adopt professional modeling software for designing or adopt professional 3D scanning equipment for scanning. Therefore, an acquisition difficulty and cost of the 3D printing data are reduced, and simplicity for an operation of the user is ensured, thereby reducing a use threshold of the 3D printing for ordinary users and improving user experiences in the smart glasses and 3D printing.

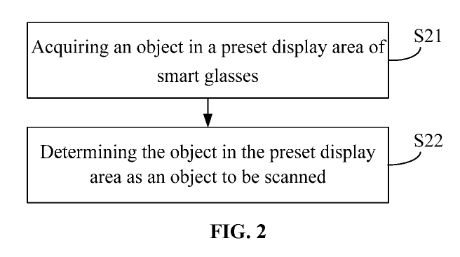

FIG. 2 is a flow chart showing a 3D printing data generation method, according to another aspect of the disclosure. As shown in FIG. 2, in another aspect, recognizing the object to be scanned includes Steps S21-S22.

In Step S21, an object in a preset display area of the smart glasses is acquired. The smart glasses may activate the preset display area when receiving a preset input from the user. For example, the preset input may include a voice input, a gesture input, or any other input that is acceptable by the smart glasses.

In Step S22, the object in the preset display area is determined as the object to be scanned. Once the user moves the smart glasses to lock the object in the preset display area, the smart glasses may start the scanning process.

In one or more embodiments, to avoid acquisition of wrong 3D data due to scanning of an adjacent object during scanning, the object to be scanned is placed in a specific scanning area for scanning. Therefore, the user needs to place the object to be scanned in the preset display area of the smart glasses when scanning the object to be scanned through the smart glasses.

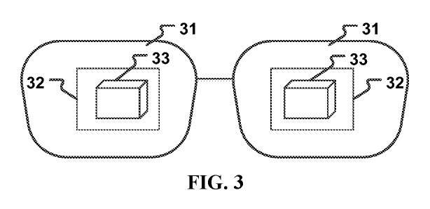

As shown in FIG. 3, when the user selects 3D scanning, a display window 32 appears in a display area 31 of the smart glasses, and the smart glasses merely scans an object in the display window 32. Therefore, the user needs to manipulate a position or angle of the smart glasses to make the object 33 positioned in the display window 32.

Therefore, the smart glasses may accurately scan the object to be scanned, and may not scan another object not required to be scanned in the user's sight. Thus, acquisition of wrong 3D scanning data is avoided, and 3D scanning accuracy is improved.

In another aspect, the operation that the object to be scanned is scanned to obtain a scanning result includes:

the object to be scanned is scanned by adopting at least one of the following sensors in the smart glasses: an infrared sensor, an image sensor, or an ultrasonic sensor.

For example, the infrared sensor may be a sensor for performing measurement by virtue of the physical property of the infrared ray. The infrared sensor may be used for target detection, object positioning, distance measurement or the like. The image sensor may include a photosensitive element configured to convert an optical image into an electronic signal, and is widely applied to digital camera and other electronic optical equipment. An electronic signal corresponding to an optical image of the object to be scanned may be obtained through the image sensor. The ultrasonic sensor may be a sensor for converting an ultrasonic signal into a signal of another energy type (usually an electrical signal), and may be used to perform distance measurement on the object to be scanned.

In some embodiments, at least one of an infrared sensor, an image recognition sensor and an ultrasonic ranging sensor is integrated in the smart glasses to endow the smart glasses with a function of scanning a 3D object, namely acquiring data of a shape, structure, color and the like of the object to be scanned. After wearing the smart glasses, the user may directly perform scanning through the smart glasses. Thus, what the user sees is directly converted into the 3D printing data. The user does not need to adopt the professional modeling software for designing or adopt the professional 3D scanning equipment for scanning, the acquisition difficulty and cost of the 3D printing data are reduced. And the simplicity for the operation of the user is ensured, thereby reducing a use threshold of the 3D printing for ordinary users and improving the user experience in the smart glasses and 3D printing.

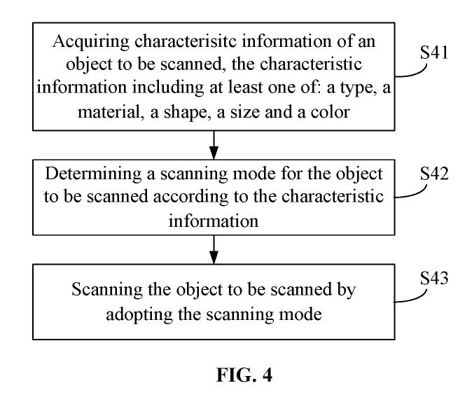

FIG. 4 is a flow chart showing a 3D printing data generation method, according to another aspect of the disclosure. As shown in FIG. 4, in one or more embodiments, the operation that the object to be scanned is scanned to obtain a scanning result includes Steps S41-S43.

In Step S41, characteristic information of the object to be scanned, the characteristic information including at least one of: a type, a material, a shape, a size, and a color is acquired. For example, the smart glasses may acquire the shape, size, and color of the object by analyzing the image of the object. The type information may include physical size information, usage information. The size information may indicate whether the object is big or small compared with a threshold value. The usage information may indicate whether the object is a toy, a tool, a ball, a fire arm, an eatable food, etc.

In Step S42, a scanning mode for the object to be scanned is determined according to the characteristic information.

In Step S43, the object to be scanned is scanned by adopting the scanning mode.

For example, different scanning modes may be set according to the size of the object. For a small-sized object, such as a small sculpture and toy model, scanning may be automatically performed, that is, the user does not need to move for scanning; and for a large-sized object, such as a large-sized sculpture and building, the user may be guided to move around the object to be scanned to comprehensively and accurately acquire 3D printing data of the object to be scanned. With the proposed 3D scanning, the user may reproduce/copy objects almost instantly with a 3D printer using the generated 3D printing data.

In one or more embodiments, 3D scanning is performed by adopting the scanning mode corresponding to the characteristic information of the object to be scanned, so that 3D scanning efficiency and accuracy are improved; moreover, the simplicity for the operation of the user is ensured, and the experiences are better.

In some embodiments, the operation that the 3D printing data is sent, according to a selected operation item, to an operating device corresponding to the operation item includes:

when the selected operation item is 3D printing, the 3D printing data is sent to a 3D printer through BlueTooth (BT) or a wireless local area network;

when the selected operation item is data sharing, the 3D printing data is sent to a terminal participating in the data sharing through the BT, the wireless local area network or instant messaging software; and

when the selected operation item is cloud storage, the 3D printing data is uploaded to a cloud server for storage, to enable the 3D printing data to be acquired from the cloud server for offsite printing, downloading or sharing.

Here, the smart glasses and the 3D printer cooperate under a same protocol, such as BT and Wi-Fi, to ensure that the scanning result of the smart glasses may be input into the 3D printer in a specific form for instant 3D printing; the 3D printing data may also be shared to other users; or, when offsite printing is required (that is, the scanned object and an actually printed finished product are not at the same place and even not at the same time), the 3D printing data may be stored in a cloud server, and may be printed off the site as desired or may be shared to the other users for downloading or usage through the cloud server. Therefore, the 3D printing data may be used more conveniently and rapidly, and the user experiences are better.

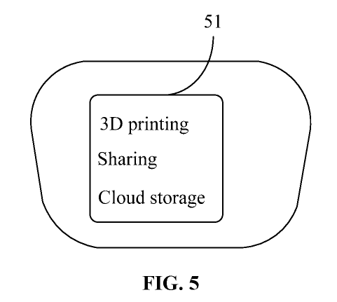

For example, as shown in the figure, after 3D scanning is completed, a dialog box is popped up in a display interface of the smart glasses to query the user about a subsequent operation over the 3D printing data. As shown in FIG. 5, operation items displayed in the dialog box 51 include: 3D printing, sharing, cloud storage, and etc. The user may select the operation item as desired. If the user selects 3D printing, the smart glasses may be connected to a preset 3D printer or a connectable 3D printer nearby and send the 3D printing data to the 3D printer for 3D printing.

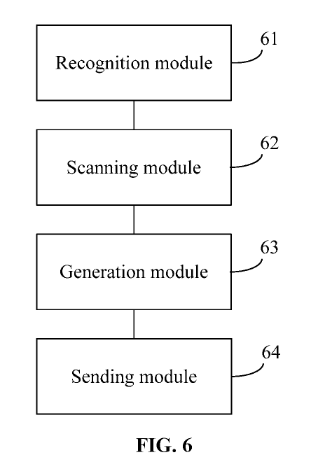

FIG. 6 is a block diagram of a 3D printing data generation device, according to an aspect of the disclosure. The device may be implemented into part or all of electronic equipment through software, hardware or a combination of the two. As shown in FIG. 6, the 3D printing data generation device is applied to smart glasses, and includes: a recognition module 61, a scanning module 62, a generation module 63 and a sending module 64.

The recognition module 61 is configured to recognize an object to be scanned.

The scanning module 62 is configured to scan the object to be scanned recognized by the recognition module 61 to obtain a scanning result.

The generation module 63 is configured to generate 3D printing data according to the scanning result of the scanning module 62.

The sending module 64 is configured to send the 3D printing data generated by the generation module 63 to an operating device corresponding to an operation item according to the selected operation item.

In the embodiment, the smart glasses have a 3D scanning function, the object to be scanned is scanned through the smart glasses, the 3D printing data in a format supported by a 3D printer is generated from the scanning result, and the 3D printing data is sent to a specified operating device in a wireless manner, such as the 3D printer, another user terminal or a cloud server. In such a manner, a user does not need to adopt professional modeling software for designing or adopt professional 3D scanning equipment for scanning, an acquisition difficulty and cost of the 3D printing data are reduced, and simplicity for an operation of the user is ensured, thereby reducing a use threshold of the 3D printing for ordinary users and improving user experiences in the smart glasses and 3D printing.

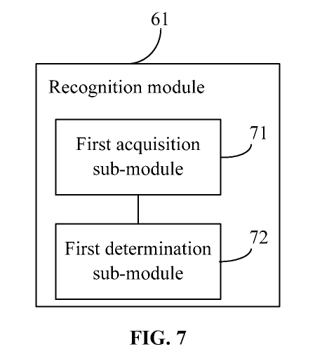

FIG. 7 is a block diagram of a recognition module, according to another aspect of the disclosure. As shown in FIG. 7, in another embodiment, the recognition module 61 includes: a first acquisition sub-module 71 and a first determination sub-module 72.

The first acquisition sub-module 71 is configured to acquire an object in a preset display area of the smart glasses.

The first determination sub-module 72 is configured to determine the object, acquired by the first acquisition sub-module 71, in the preset display area as the object to be scanned.

In the embodiment, for avoiding acquisition of wrong 3D data due to scanning of an adjacent object during scanning, the object to be scanned is placed in a specific scanning area for scanning. Therefore, the user needs to place the object to be scanned in the preset display area of the smart glasses when scanning the object to be scanned through the smart glasses.

As shown in FIG. 3, when the user selects 3D scanning, a display window 32 appears in a display area 31 of the smart glasses, and the smart glasses only scans an object in the display window 32. Therefore, the user needs to regulate a position or angle of the smart glasses to make the object 33 to be scanned positioned in the display window 32.

Therefore, the smart glasses may accurately scan the object to be scanned, and may not scan another object not required to be scanned in the user's sight. Therefore, acquisition of wrong 3D scanning data is avoided, and 3D scanning accuracy is improved.

In another embodiment, the scanning module 62 is configured to scan the object to be scanned by adopting at least one of the following sensors on the smart glasses: an infrared sensor, an image sensor or an ultrasonic sensor.

Here, the infrared sensor is a sensor for performing measurement by virtue of the physical property of the infrared ray. The infrared sensor may be used for target detection, object positioning, distance measurement or the like. The image sensor is a photosensitive element, is a device for converting an optical image into an electronic signal, and is widely applied to a digital camera and other electronic optical equipment. An electronic signal corresponding to an optical image of the object to be scanned may be obtained through the image sensor. The ultrasonic sensor is a sensor for converting an ultrasonic signal into a signal of another energy type (usually an electrical signal), and may be used to perform distance measurement on the object to be scanned.

In the embodiment, at least one of an infrared sensor, an image recognition sensor and an ultrasonic ranging sensor is integrated in the smart glasses to endow the smart glasses with a function of scanning a 3D object, namely acquiring data of a shape, structure, color and the like of the object to be scanned. The user, after wearing the smart glasses, may directly perform scanning through the smart glasses, what the user sees is directly converted into the 3D printing data, the user does not need to adopt the professional modeling software for designing or adopt the professional 3D scanning equipment for scanning, the acquisition difficulty and cost of the 3D printing data are reduced, and the simplicity for the operation of the user is ensured, thereby reducing a use threshold of the 3D printing for ordinary users and improving the user experience in the smart glasses and 3D printing.

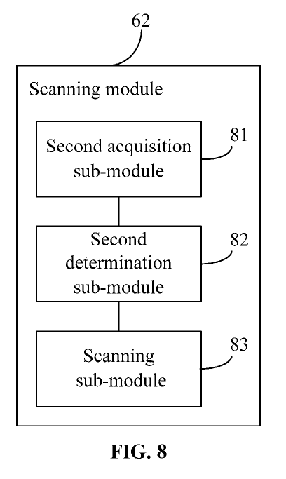

FIG. 8 is a block diagram of a scanning module, according to another aspect of the disclosure. As shown in FIG. 8, in the embodiment, the scanning module 62 includes: a second acquisition sub-module 81, a second determination sub-module 82 and a scanning sub-module 83.

The second acquisition sub-module 81 is configured to acquire characteristic information of the object to be scanned recognized by the recognition module 61, the characteristic information including at least one of: a type, a material, a shape, a size, and a color.

The second determination sub-module 82 is configured to determine a scanning mode for the object to be scanned according to the characteristic information acquired by the second acquisition sub-module 81.

The scanning sub-module 83 is configured to scan the object to be scanned by adopting the scanning mode determined by the second determination sub-module 82.

For example, different scanning modes may be set according to the size of the object. For a small-sized object, such as a small sculpture and toy model, scanning may be automatically performed, that is, the user does not need to move for scanning; and for a large-sized object, such as a large-sized sculpture and building, the user may be guided to move around the object to be scanned to comprehensively and accurately acquire 3D printing data of the object to be scanned.

In the embodiment, 3D scanning is performed by adopting the scanning mode corresponding to the characteristic information of the object to be scanned, so that 3D scanning efficiency and accuracy are improved; moreover, the simplicity for the operation of the user is ensured, and the experiences are better.

In another embodiment, the sending module 64 is configured to, when the selected operation item is 3D printing, send the 3D printing data to a 3D printer through BT or a wireless local area network; when the selected operation item is data sharing, send the 3D printing data to a terminal participating in the data sharing through BT, the wireless local area network or instant messaging software; and when the selected operation item is cloud storage, upload the 3D printing data to a cloud server for storage, to enable the 3D printing data to be acquired from the cloud server for offsite printing, downloading or sharing.

Here, the smart glasses and the 3D printer cooperate under the same protocol, such as BT and Wi-Fi, to ensure that the scanning result of the smart glasses may be input into the 3D printer in a specific form for instant 3D printing; the 3D printing data may also be shared to another user; or, when offsite printing is required (that is, the scanned object and an actually printed finished product are not at the same place and even not at the same time), the 3D printing data may be stored in a cloud server, and may be printed off the site as desired, or may be shared to the other user for downloading or usage through the cloud server. Therefore, the 3D printing data may be used more conveniently and rapidly, and the user experiences are better.

For example, as shown in the figure, after 3D scanning is ended, a dialog box is popped up in a display interface of the smart glasses to query the user about a subsequent operation over the 3D printing data. As shown in FIG. 5, operation items displayed in the dialog box 51 include: 3D printing, sharing, cloud storage, and etc. The user may select the operation item as desired. If the user selects 3D printing, the smart glasses may be connected to a preset 3D printer or a connectable 3D printer nearby and send the 3D printing data to the 3D printer for 3D printing.

An embodiment of the present disclosure further provides a 3D printing data generation device, which is applied to smart glasses and includes: a processor; and a memory configured to store instructions executable by the processor. The processor is configured to:

recognize an object to be scanned;

scan the object to be scanned to obtain a scanning result;

generate 3D printing data according to the scanning result; and

send, according to a selected operation item, the 3D printing data to an operating device corresponding to the operation item.

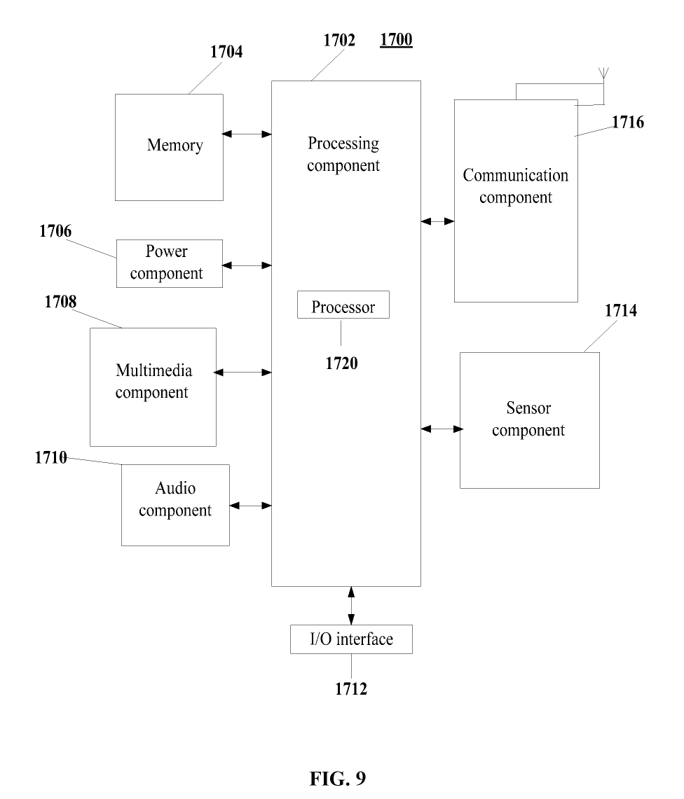

FIG. 9 is a block diagram of a 3D printing data generation device, according to an aspect of the disclosure. The device 1700 is applied to smart glasses.

The device 1700 may include one or more of the following components: a processing component 1702, a memory 1704, a power component 1706, a multimedia component 1708, an audio component 1710, an Input/Output (I/O) interface 1712, a sensor component 1714, and a communication component 1716.

The processing component 1702 typically controls overall operations of the device 1700, such as the operations associated with display, telephone calls, data communications, camera operations, and recording operations. The processing component 1702 may include one or more processors 1720 to execute instructions to perform all or part of the steps in the abovementioned method. Moreover, the processing component 1702 may include one or more modules which facilitate interaction between the processing component 1702 and the other components. For instance, the processing component 1702 may include a multimedia module to facilitate interaction between the multimedia component 1708 and the processing component 1702.

The memory 1704 is configured to store various types of data to support the operation of the device 1700. Examples of such data include instructions for any application programs or methods operated on the device 1700, contact data, phonebook data, messages, pictures, video, etc. The memory 1704 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 1706 provides power for various components of the device 1700. The power component 1706 may include a power management system, one or more power supplies, and other components associated with the generation, management and distribution of power for the device 1700.

The multimedia component 1708 includes a screen providing an output interface between the device 1700 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action, but also detect a duration and pressure associated with the touch or swipe action. In some embodiments, the multimedia component 1708 includes a front camera and/or a rear camera. The front camera and/or the rear camera may receive external multimedia data when the device 1700 is in an operation mode, such as a photographing mode or a video mode. Each of the front camera and the rear camera may be a fixed optical lens system or have focusing and optical zooming capabilities.

The audio component 1710 is configured to output and/or input an audio signal. For example, the audio component 1710 includes a Microphone (MIC), and the MIC is configured to receive an external audio signal when the device 1700 is in the operation mode, such as a call mode, a recording mode and a voice recognition mode. The received audio signal may be further stored in the memory 1704 or sent through the communication component 1716. In some embodiments, the audio component 1710 further includes a speaker configured to output the audio signal.

The I/O interface 1712 provides an interface between the processing component 1702 and a peripheral interface module, and the peripheral interface module may be a keyboard, a click wheel, a button and the like. The button may include, but not limited to: a home button, a volume button, a starting button and a locking button.

The sensor component 1714 includes one or more sensors configured to provide status assessment in various aspects for the device 1700. For instance, the sensor component 1714 may detect an on/off status of the device 1700 and relative positioning of components, such as a display and small keyboard of the device 1700, and the sensor component 1714 may further detect a change in a position of the device 1700 or a component of the device 1700, presence or absence of contact between the user and the device 1700, orientation or acceleration/deceleration of the device 1700 and a change in temperature of the device 1700. The sensor component 1714 may include a proximity sensor configured to detect presence of an object nearby without any physical contact. The sensor component 1714 may also include a light sensor, such as a Complementary Metal Oxide Semiconductor (CMOS) or Charge Coupled Device (CCD) image sensor, configured for use in an imaging application. In some embodiments, the sensor component 1714 may also include an acceleration sensor, a gyroscope sensor, a magnetic sensor, a pressure sensor or a temperature sensor.

The communication component 1716 is configured to facilitate wired or wireless communication between the device 1700 and another device. The device 1700 may access a communication-standard-based wireless network, such as a Wi-Fi network, a 2nd-Generation (2G) or 3rd-Generation (3G) network or a combination thereof. In an aspect of the disclosure, the communication component 1716 receives a broadcast signal or broadcast associated information from an external broadcast management system through a broadcast channel. For example, the communication component 1716 further includes a Near Field Communciation (NFC) module to facilitate short-range communication. For example, the NFC module may be implemented on the basis of a Radio Frequency Identification (RFID) technology, an Infrared Data Association (IrDA) technology, an Ultra-WideBand (UWB) technology, a BT technology and another technology.

In one or more exemplary embodiments, the device 1700 may be implemented by one or more circuitry, which include one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components. The device 1700 may use the circuitries in combination with the other hardware or software components for performing the above described methods. Each module, sub-module, unit, or sub-unit in the disclosure may be implemented at least partially using the one or more circuitries.

In one or more exemplary embodiments, there is also provided a non-transitory computer-readable storage medium including an instruction, such as the memory 1704 including an instruction, and the instruction may be executed by the processor 1720 of the device 1700 to implement the abovementioned method. For example, the non-transitory computer-readable storage medium may be a ROM, a Compact Disc Read-Only Memory (CD-ROM), a magnetic tape, a floppy disc, optical data storage equipment and the like.

According to a non-transitory computer-readable storage medium, instructions in the storage medium are executed by the processor of the device 1700 to enable the device 1700 to execute the abovementioned 3D printing data generation method, the method including:

recognizing an object to be scanned;

scanning the object to be scanned to obtain a scanning result;

generating 3D printing data according to the scanning result; and

sending, according to a selected operation item, the 3D printing data to an operating device corresponding to the operation item.

In some embodiments, recognizing the object to be scanned includes:

acquiring an object in a preset display area of the smart glasses; and

determining the object in the preset display area as the object to be scanned.

In another embodiment, the scanning the object to be scanned to obtain the scanning result includes:

scanning the object to be scanned by adopting at least one of an infrared sensor, an image sensor or an ultrasonic sensor in the smart glasses.

In some embodiments, scanning the object to be scanned to obtain a scanning result includes:

acquiring characteristic information of the object to be scanned, the characteristic information including at least one of: a type, a material, a shape, a size, and a color;

determining a scanning mode for the object to be scanned according to the characteristic information; and

scanning the object to be scanned by adopting the scanning mode.

In some embodiments, sending, according to a selected operation item, the 3D printing data to the operating device corresponding to the operation item includes:

when the selected operation item is 3D printing, sending the 3D printing data to a 3D printer through BT or a wireless local area network;

when the selected operation item is data sharing, sending the 3D printing data to a terminal participating in the data sharing through the BT, the wireless local area network or instant messaging software; and

when the selected operation item is cloud storage, uploading the 3D printing data to a cloud server for storage to enable the 3D printing data to be acquired from the cloud server for offsite printing, downloading or sharing.

Other embodiments of the present disclosure will be apparent to those skilled in the art from consideration of the specification and practice of the present disclosure. This application is intended to cover any variations, uses, or adaptations of the embodiments of the present disclosure following the general principles thereof and including such departures from the embodiments of the present disclosure as come within known or customary practice in the art. It is intended that the specification and examples be considered as exemplary only, with a true scope and spirit of the present disclosure being indicated by the following claims.

It will be appreciated that the present disclosure are not limited to the exact construction that has been described above and illustrated in the accompanying drawings, and that various modifications and changes may be made without departing from the scope thereof. It is intended that the scope of the present disclosure only be limited by the appended claims.

The technical solution provided by the embodiments of the present disclosure may achieve the following beneficial effects.

In the embodiments, the smart glasses have a 3D scanning function, the object to be scanned is scanned through the smart glasses, the 3D printing data in a format supported by the 3D printer is generated from the scanning result, and the 3D printing data is sent to a specified operating device, such as the 3D printer, another user terminal or the cloud server, in a wireless manner. In such a manner, a user does not need to adopt professional modeling software for designing or adopt professional 3D scanning equipment for scanning, an acquisition difficulty and cost of the 3D printing data are reduced, and simplicity for an operation of the user is ensured, thereby reducing a use threshold of 3D printing for ordinary users and improving user experiences in the smart glasses and 3D printing.

To avoid acquisition of wrong 3D data due to scanning of an adjacent object during scanning, the object to be scanned is placed in a specific scanning area for scanning. Therefore, the user needs to place the object is placed to be scanned in the preset display area of the smart glasses when scanning the object to be scanned through the smart glasses.

In one or more embodiments, at least of an infrared sensor, an image recognition sensor and an ultrasonic ranging sensor is integrated in the smart glasses to endow the smart glasses with a function of scanning a 3D object, namely acquiring data of a shape, structure, color and the like of the object to be scanned. The user, after wearing the smart glasses, may directly perform scanning through the smart glasses, what the user sees is directly converted into the 3D printing data, the user does not need to adopt the professional modeling software for designing or adopt the professional 3D scanning equipment for scanning, the acquisition difficulty and cost of the 3D printing data are reduced, and the simplicity for the operation of the user is ensured, thereby reducing a use threshold of the 3D printing for ordinary users and improving the user experiences in the smart glasses and 3D printing.

Alternatively or additionally, 3D scanning is performed by adopting the scanning mode corresponding to the characteristic information of the object to be scanned, so that 3D scanning efficiency and accuracy are improved; moreover, the simplicity for the operation of the user is ensured, and the experiences are better.

Alternatively or additionally, the smart glasses and the 3D printer cooperate under a same protocol, such as BT and Wireless Fidelity (Wi-Fi), to ensure that the scanning result of the smart glasses may be input into the 3D printer in a specific form for instant 3D printing; the 3D printing data may also be shared to other users; or, when offsite printing is required (that is, the scanned object and an actually printed finished product are not at the same place and even not at the same time), the 3D printing data may be stored in a cloud server, and may be printed off the site as desired or may be shared to other users for downloading or usage through the cloud server. Therefore, the 3D printing data may be used more conveniently and rapidly, and the user experiences are better.

Terms adopted in the present disclosure are intended not to limit the present disclosure but to describe specific embodiments. “A,” “said,” and “the” representing a singular form in the present disclosure and the appended claims are also intended to include a plural form unless other meanings are clearly represented in the context. It should also be understood that the term “and/or” in the present disclosure refers to and includes any one or any possible combination of one or more associated items which are listed.

It should also be understood that terms first, second, third and the like may be adopted to describe various kinds of information in the present disclosure, but these information should not be limited to these terms. These terms are only adopted to distinguish the same type of information. For example, without departing from the scope of the present disclosure, first information may also be called second information, and similarly, second information may also be called first information. It depends on the context. For example, the term “if” used here may be explained as “when . . . ” or “while . . . ” or “in response to determination.”

Other embodiments of the present disclosure will be apparent to those skilled in the art from consideration of the specification and practice of the present disclosure. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

What is claimed is:

1. A method for generating three-dimensional (3D) printing data, applied to smart glasses, the method comprising:
recognizing an object to be scanned;
scanning the object to be scanned to obtain a scanning result;
generating the 3D printing data according to the scanning result; and
sending, according to a selected operation item, the 3D printing data to an operating device corresponding to the operation item.

2. The method of claim 1, wherein recognizing the object to be scanned comprises:
acquiring an object in a preset display area of the smart glasses; and
determining the object in the preset display area as the object to be scanned.

3. The method of claim 1, wherein scanning the object to be scanned to obtain a scanning result comprises:
scanning the object to be scanned by adopting at least one of an infrared sensor, an image sensor and an ultrasonic sensor in the smart glasses.

4. The method of claim 1, wherein scanning the object to be scanned to obtain a scanning result comprises:
acquiring characteristic information of the object to be scanned, the characteristic information comprising at least one of: a type, a material, a shape, a size, and a color;
determining a scanning mode for the object to be scanned according to the characteristic information; and
scanning the object to be scanned by adopting the scanning mode.

5. The method of claim 1, wherein sending, according to a selected operation item, the 3D printing data to the operating device corresponding to the operation item comprises:
when the selected operation item is 3D printing, sending the 3D printing data to a 3D printer through BlueTooth (BT) or a wireless local area network;
when the selected operation item is data sharing, sending the 3D printing data to a terminal participating in the data sharing through the BT, the wireless local area network or instant messaging software; and
when the selected operation item is cloud storage, uploading the 3D printing data to a cloud server for storage, to enable the 3D printing data to be acquired from the cloud server for offsite printing, downloading or sharing.

6. A three-dimensional (3D) printing data generation device, applied to smart glasses and comprising:
a processor; and
a memory configured to store instructions executable by the processor,
wherein the processor is configured to:
recognize an object to be scanned;
scan the object to be scanned to obtain a scanning result;
generate 3D printing data according to the scanning result; and
send, according to a selected operation item, the 3D printing data to an operating device corresponding to the operation item.

7. The device of claim 6, wherein the processor is configured to:
acquire an object in a preset display area of the smart glasses; and
determine the object in the preset display area as the object to be scanned.

8. The device of claim 6, wherein the processor is configured to:
scan the object to be scanned by adopting at least one of an infrared sensor, an image sensor and an ultrasonic sensor in the smart glasses.

9. The device of claim 6, wherein the processor is configured to:
acquire characteristic information of the object to be scanned, the characteristic information comprising at least one of: a type, a material, a shape, a size, and a color;
determine a scanning mode for the object to be scanned according to the characteristic information; and
scan the object to be scanned by adopting the scanning mode.

10. The device of claim 6, wherein the processor is configured to:
when the selected operation item is 3D printing, send the 3D printing data to a 3D printer through BlueTooth (BT) or a wireless local area network;
when the selected operation item is data sharing, send the 3D printing data to a terminal participating in the data sharing through the BT, the wireless local area network or instant messaging software; and
when the selected operation item is cloud storage, upload the 3D printing data to a cloud server for storage, to enable the 3D printing data to be acquired from the cloud server for offsite printing, downloading or sharing.

11. A non-transitory computer-readable storage medium, having stored therein instructions that, when executed by a processor, cause the processor to perform a three-dimensional (3D) printing data generation, the method comprising:
recognizing an object to be scanned;
scanning the object to be scanned to obtain a scanning result;
generating 3D printing data according to the scanning result; and
sending, according to a selected operation item, the 3D printing data to an operating device corresponding to the operation item.

12. The non-transitory computer-readable storage medium of claim 11, wherein recognizing the object to be scanned comprises:
acquiring an object in a preset display area of the smart glasses; and
determining the object in the preset display area as the object to be scanned.

13. The non-transitory computer-readable storage medium of claim 11, wherein scanning the object to be scanned to obtain a scanning result comprises:
scanning the object to be scanned by adopting at least one of an infrared sensor, an image sensor and an ultrasonic sensor in the smart glasses.

14. The non-transitory computer-readable storage medium of claim 11, wherein scanning the object to be scanned to obtain a scanning result comprises:
acquiring characteristic information of the object to be scanned, the characteristic information comprising at least one of: a type, a material, a shape, a size, and a color;
determining a scanning mode for the object to be scanned according to the characteristic information; and
scanning the object to be scanned by adopting the scanning mode.

15. The non-transitory computer-readable storage medium of claim 11, wherein sending, according to a selected operation item, the 3D printing data to the operating device corresponding to the operation item comprises:
when the selected operation item is 3D printing, sending the 3D printing data to a 3D printer through BlueTooth (BT) or a wireless local area network;
when the selected operation item is data sharing, sending the 3D printing data to a terminal participating in the data sharing through the BT, the wireless local area network or instant messaging software; and
when the selected operation item is cloud storage, uploading the 3D printing data to a cloud server for storage, to enable the 3D printing data to be acquired from the cloud server for offsite printing, downloading or sharing.
